(19) United States
(12) Patent Application Publication
(10) Pub. No.: US 2005/0279973 A1
(43) Pub. Date: Dec. 22, 2005

(54) Luggage cart vertical reciprocating conveyor

(76) Inventor: Jared Andrew Rea, Clinton, UT (US)

Correspondence Address: JARED ANDREW REA, 2544 WEST 1675 NORTH, CLINTON, UT, 84015, US

(21) Appl. No.: 11/073,108

(22) Filed: Mar. 4, 2005

Related U.S. Application Data
(60) Provisional application No. 60/551,530, filed on Mar. 9, 2004.

(51) Int. Cl. B66F 1/00

(52) U.S. Cl. 254/1

(57) ABSTRACT

A wheeled cart capable of carrying luggage is reciprocated vertically between at least two vertical elevations. The luggage cart is manually pushed into a carriage contained within a support structure that acts as its vertical guide way. The carriage has no platform and is designed to capture the cart with rails suitable for lifting it vertically from its loading elevation to a higher elevation by a hoist. The cart is unloaded and reloaded with luggage and then reciprocates down to its starting position where it is pulled out of the carriage and rolled to a different unloading location.

### BACKGROUND OF THE INVENTION

Within the airline passenger transportation industry there occasionally exists a situation that requires a passenger to surrender their luggage at the boarding gate before embarking on the aircraft. The luggage then needs to be taken from the airport terminal building to the tarmac for loading into the cargo bay of the aircraft. The reverse is true for airplane arrivals.

A number of methods have been used to solve the problem including the use of luggage carts in conjunction with conventional elevators, baggage slides and a cab-mounted bag cart elevator.

All of the elevators mentioned above have one common component - a vertically reciprocating platform onto which a luggage cart can be pushed. Recognizing that this type of luggage lift device could conceivably convey people, a safer design was sought to allow only the luggage cart to be elevated without the use of a platform.

An elevator that contains no platform and is designed to lift only a specific luggage cart without the probability of lifting a person is a significant variation from the current state of the art.

Another limitation with existing luggage lift elevators is that a ramp or hinged plate is often required to interface the lift platform with the surrounding ground. This invention overcomes that limitation by having no ramp or hinged plates or ground interfaces at all.

This invention was designed for use as a luggage cart vertical reciprocating conveyor in the airline passenger luggage industry but could easily be used in other material handling situations requiring the use of wheeled carts that need to be conveyed vertically.

### SUMMARY OF THE INVENTION

In one form of the invention a support structure has an electric chain hoist mounted at the top of its frame. The hoist is also connected to a carriage or lifting cradle that reciprocates vertically within the confines of the support structure via the action of the hoist. The lifting cradle has a frame to which lifting rails are mounted which rails engage rails mounted to the top of the luggage cart frame.

The wheeled luggage cart is filled or emptied with luggage in a location remote from the support structure and then wheeled through a doorway in the bottom of the support structure to engage the lifting cradle. As the cart enters the support structure the lifting rails on top of the cart are positioned directly above the cradle lifting rails. There is a gap between the lifting cradle rails and the luggage cart rails, this gap allows for variations in the ground onto which the support frame is mounted. The fact that the luggage cart is positioned within the lifting cradle at an angle other than 90° to the vertical axis of the support structure has no impact of the units' ability to lift because the bag cart will self level as the cradle rails engage the luggage cart rails.

It is a specific feature of the invention that the lifting cradle rails are set below the cart lifting rails and self level the luggage cart as the lifting cradle moves upward to engage them. In another form the invention could use a single rail on both the lifting cradle and luggage cart.

The lifting cradle is confined laterally within the support structure by guide rollers, which are mounted to its frame. In another form, the invention could use sliding blocks or magnetic bearings in lieu of the guide rollers.

When the lifting cradle and luggage cart is in the upper position a door in the support structure is opened to allow access for unloading/loading the luggage. The luggage cart cannot be removed from the lifting cradle in its upper position; it can only be loaded and unloaded.

### BRIEF DESCRIPTION OF THE DRAWINGS

SHEET 1 Assembled Luggage Cart Vertical Reciprocating Conveyor

FIG. 1 Front Elevation

FIG. 2 Right Side View

FIG. 3 Top View.

The support structure is shown without cladding which would normally cover the frame. The cladding is not shown on the drawing so that the inner workings of the machine can be seen.

SHEET 2 Lifting Cradle (Previously called carriage)

FIG. 4 Left Side View

FIG. 5 Front View

FIG. 6 Top View

SHEET 3 Wheeled Luggage Cart

FIG. 7 Left Side View

FIG. 8 Front View

FIG. 9 Top View.

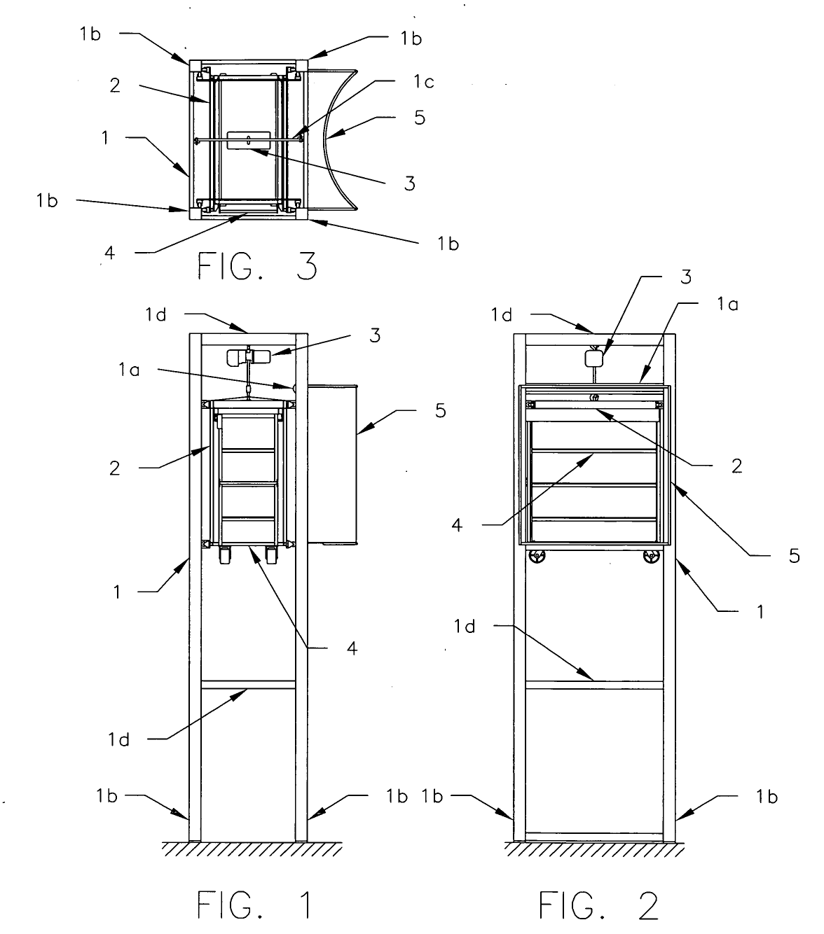

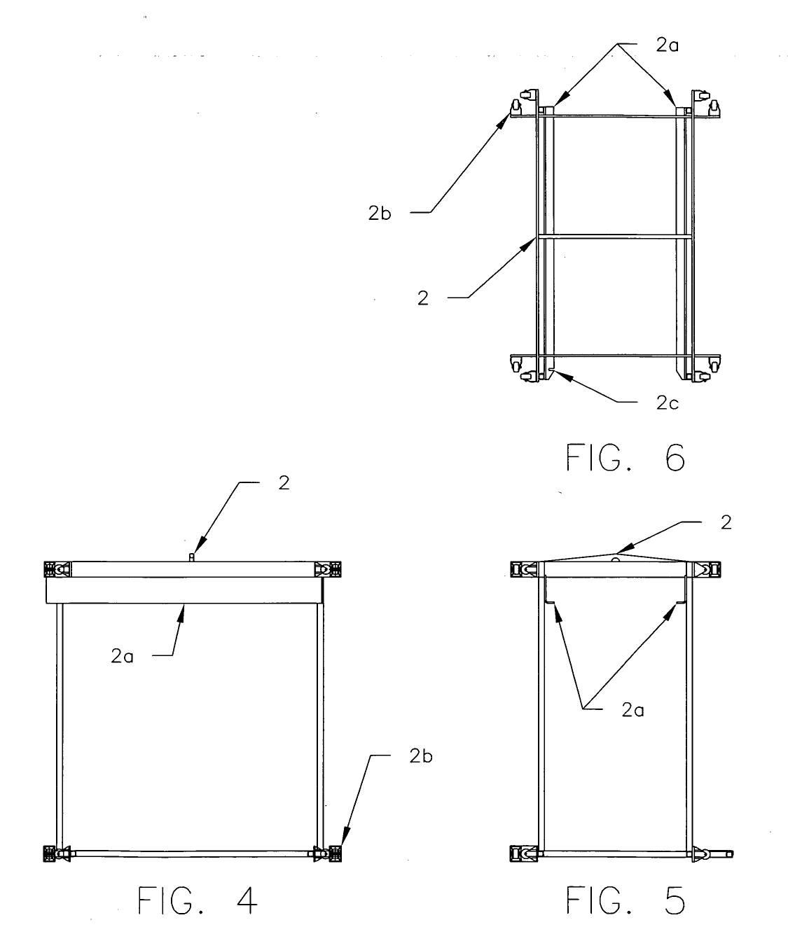

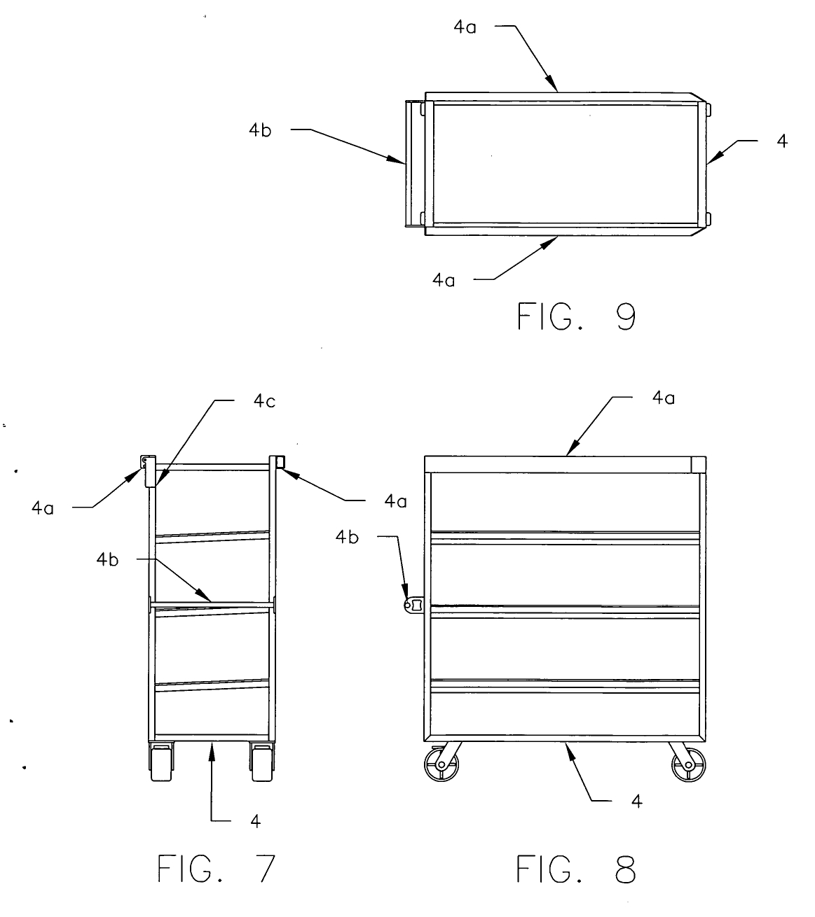

Before one embodiment of the invention is explained in detail it is to be understood that the invention is not limited in its application to the details of construction and the arrangement of components set forth in the following description or illustrated drawings. The invention is capable of other embodiments and of being practiced or being carried out in various ways. It is also to be understood that the phraseology and terminology used herein is for the purpose of description and should not be regarded as limiting.

### DETAILED DESCRIPTION OF THE ILLUSTRATED EMBODIMENT

The Luggage Cart Vertical Reciprocating Conveyor-has four main- components: Support structure 1, Lifting cradle 2, Electric hoist 3 and the Wheeled luggage cart 4.

The support structure 1 is made from four vertical tubes 1b set parallel to each other in the form of a rectangle. The said vertical tubes are held in place by horizontal members Id. An electric hoist 3 is mounted at the top of support structure 1, attached to support member 1c. The hoist 3 is also connected to a lifting cradle 2 that reciprocates vertically within the confines of the support structure 1 via the action of the hoist 3.

When the lifting cradle 2 is in its lowest set position, it captures a wheeled luggage cart 4 as it is pushed through an opening/doorway at the bottom of the support structure 1. In one form of the invention the lifting cradle 2 has a frame into which are build lifting rails 2a. In another form of the invention there may be more or less of these lifting rails. The wheeled luggage cart 4 also has lifting rails 4a mounted on its top.

The wheeled luggage cart 4 is filled or emptied with luggage in a location remote from the support frame 1 and then pushed via its handle 4b through a opening/doorway in the bottom of the support structure 1. As the wheeled luggage cart 4 enters the support structure 1 the lifting rails 4a on top of the wheeled luggage cart 4 are positioned directly above the lifting rails 2a on the lifting cradle 2. There is a gap between the lifting cradle rails 2a and the wheeled luggage cart rails 4a, this gap allows for variations in the ground onto which the support frame 1 is mounted and the wheeled luggage cart 4 rolls. One of the main strengths of the invention is that if the wheeled luggage cart 4 is positioned in the lifting cradle 2 at an angle other than 90° to the vertical axis of the support structure 1 the cart lifting cradle 2a will align the wheeled luggage cart 4 as the electric hoist 3 lifts it.

The lifting cradle 2 is confined laterally in both the X & Y directions by multiple guide rollers 2b, which are mounted to its frame.

When the lifting cradle 2 and luggage cart 4 are in the upper position a roller door 1a in the support structure is opened to allow access for unloading and loading luggage. The luggage cart 4 cannot be removed from the lifting cradle 2 in its upper position; it can only be loaded and unloaded. There is also a cart safety catch 4c mounted to the bag cart 4. The cart safety catch 4c rotates as it hits the lifting cradle rail 2a and as it slides against the edge of the said rail drops into a notch 2c. While the cart safety catch 4c is engaged within the lifting cradle rail- notch 2c the wheeled luggage cart-4 is prevented from sliding out of the lifting cradle 2.

The support frame 1 is connected to a building or access area via an interface 5. It is through the interface 5 that access is gained to load and unload the wheeled luggage cart 4 in the upper position. The interface 5 can be eliminated from the design without affecting the workings of the invention; the support structure would be attached directly to the passenger boarding bridge, airport terminal building or any other building. The above-described embodiment of this invention has been realized with the successful development of working versions of the machine.

1. A Luggage Cart Vertical Reciprocating Conveyor comprising:
A. A support structure that acts as a vertical guide way for a carriage or cradle
B. A cradle that reciprocates vertically within the confines of the guide way via the action of a hoist and rope/chain
C. A luggage cart that is captured by lifting rails on the cradle and thus also vertically reciprocates.

2. The lifting cradle described in claim 1 has lifting rails set below the cart lifting rail or rails and self level the luggage cart as the lifting cradle moves upward to engage them.

3. The bag cart described in claim 1 has an automatically engaging latch that engages onto at least one cradle lifting rail to prevent the cart moving out of the cradle while being lifted or lowered.

4. The luggage cart described in claim 1 rolls on the ground and enters the support structure without the need for a ramp or ramp plate on the cradle or support structure.

5. The lifting cradle described in claim 1 has no floor or platform for an object or person to be placed on.
